(19) United States
(12) Patent Application Publication
(10) Pub. No.: US 2015/0333835 A1
(43) Pub. Date: Nov. 19, 2015

(54) OPTICAL TRANSMITTER, OPTICAL RECEIVER, AND OPTICAL TRANSMISSION METHOD

(71) Applicant: FUJITSU LIMITED, Kawasaki-shi (JP)

(72) Inventor: Yoshinobu MATSUKAWA, Kawasaki (JP)

(21) Appl. No.: 14/696,707

(22) Filed: Apr. 27, 2015

(30) Foreign Application Priority Data
May 16, 2014 (JP) 2014-102515

(51) Int. Cl. H04B 10/572; H04B 10/60; H04J 14/02

(52) U.S. Cl. CPC H04B 10/572; H04J 14/0212; H04J 14/0227; H04B 10/60

(57) ABSTRACT

An optical transmitter includes: a plurality of optical modulators, each and a driver by which a modulation format is variable; and a wavelength selection unit configured to selectively outputs modulation optical signals generated by the optical modulators to a first output port corresponding to a first optical transmission degree and a second output port corresponding to a second optical transmission degree in a unit of wavelength.

### CROSS-REFERENCE TO RELATED APPLICATION

This application is based upon and claims the benefit of priority of the prior Japanese Patent Application No. 2014-102515, filed on May 16, 2014, the entire contents of which are incorporated herein by reference.

### FIELD

The embodiment discussed herein is related to an optical transmitter, an optical receiver, and an optical transmission method.

### BACKGROUND

As an example of an optical transmission technology, technologies described in Japanese Laid-Open Patent Publication Nos. 2012-191452, 2006-140598, and 2010-081374 have been known. For example, Japanese Laid-Open Patent Publication No. 2012-191452 discusses a multi-carrier optical transmitter capable of applying different modulation rates to subcarriers and coping with change in transmission distance.

For example, Japanese Laid-Open Patent Publication No. 2006-140598 discuses an optical transmitter (a cross-connect device) having a colorless and directionless (CD) function.

For example, Japanese Laid-Open Patent Publication No. 2010-081374 discuses an optical cross-connect device that adds and drops inputs and outputs of a plurality of transponders to any of a plurality of input and output degrees by using an N×M (N and M are integers of 2 or more) wavelength selective switch (WSS). Japanese Laid-Open Patent Publication No. 2010-081374 also discusses an optical cross-connect device having a multicast switch (MCS) configuration which is a combined configuration of a 1×m (m is an integer of 2 or more which satisfies m<M) optical coupler (OC) and a 1×N WSS, as an alternative configuration of the N×M WSS.

However, in the related art, modulation optical signals corresponding to a plurality of subcarrier optical signals are just transmitted from one transponder to the same optical transmission degree (hereinafter, simply referred to as a “degree”). For this reason, it is difficult to freely change the number of subcarrier optical signals for every degree.

### SUMMARY

According to an aspect of the embodiments, an optical transmitter includes: a plurality of optical modulators, each and a driver by which a modulation format is variable; and a wavelength selection unit configured to selectively outputs modulation optical signals generated by the optical modulators to a first output port corresponding to a first optical transmission degree and a second output port corresponding to a second optical transmission degree in a unit of wavelength.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A, 1B, and 1C are block diagrams illustrating configuration examples of a multi-carrier transponder (MTPD) according to an embodiment;

FIG. 2 is a block diagram illustrating a configuration example in which the MTPD illustrated in FIG. 1A is connected to a ROADM;

FIG. 3 is a block diagram illustrating a configuration example in which the MTPD illustrated in FIG. 1A is connected to the ROADM;

FIGS. 4A and 4B are block diagrams respectively illustrating a configuration example of an MCS illustrated in FIGS. 2 and 3;

FIG. 5 is a block diagram illustrating a configuration example of a WDM optical transmission system including a plurality of ROADMs (CDC ROADMs) having CDC functions according to the embodiment;

FIG. 6 is a block diagram illustrating a configuration example of an MTPD as a comparative example of the MTPD illustrated in FIG. 1A;

FIG. 7 is a block diagram illustrating a configuration example in which the MTPD illustrated in FIG. 6 is connected to the ROADM;

FIG. 8 is a block diagram illustrating a configuration example in which the MTPD illustrated in FIG. 6 is connected to the ROADM;

FIG. 9 is a block diagram illustrating an example in which the configuration illustrated in FIGS. 7 and 8 is applied to the WDM optical transmission system;

FIG. 10 is a diagram for describing there is a case where it is difficult to freely transmit optical signals to different degrees through the ROADM in a unit of a subcarrier in the configuration illustrated in FIGS. 6 to 9;

FIG. 11 is a diagram for describing there is a case where it is difficult to freely transmit the optical signals to different degrees through the ROADM in a unit of the subcarrier in the configuration illustrated in FIGS. 6 to 9;

FIG. 12 is a block diagram illustrating an example of a connection relationship between a MTPD and a ROADM according to a first modification example;

FIG. 13 is a block diagram illustrating a configuration example in which a contention 4×2 WSS and a contention 2×4 WSS illustrated in FIG. 12 are generalized to a contention N×M WSS and a contention M×N WSS;

FIG. 14 is a block diagram illustrating an example of a connection relationship between a MTPD and a ROADM according to a second modification example;

FIG. 15 is a block diagram illustrating a configuration example in which the MTPD illustrated in FIG. 13 is applied to the WDM optical transmission system including a plurality of ROADMs (CDC ROADMs) having the CDC functions;

FIG. 16 is a block diagram illustrating a configuration example in which a non-blocking 4×2 WSS and a non-blocking 2×4 WSS illustrated in FIG. 14 are respectively generalized to a non-blocking N×M WSS and a non-blocking M×N WSS; and

FIG. 17 is a block diagram illustrating a configuration example in which the number of input ports in an optical coupler, WSSs, and an optical splitter illustrated in FIGS. 1A, 2, and 3 is generalized.

### DESCRIPTION OF EMBODIMENT

Hereinafter, an embodiment will be described with reference to the drawings. However, the embodiment described below is only example, and is not intended to exclude applications of the technology and various modifications which are not indicated in the following embodiment. Throughout the drawings used in the following embodiment, components assigned the same reference numerals represent the same components or similar components unless otherwise stated.

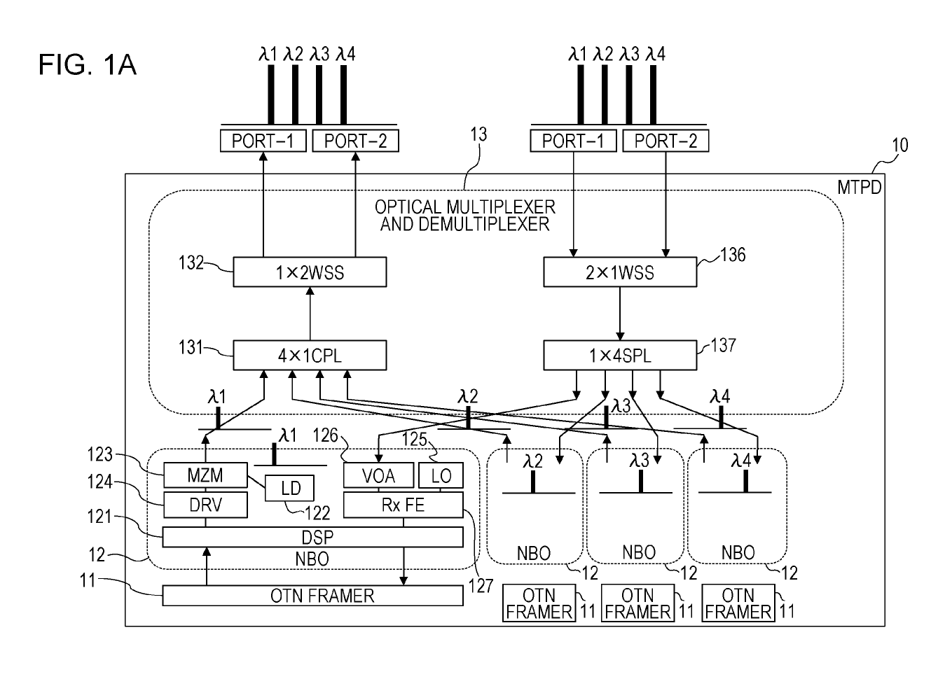

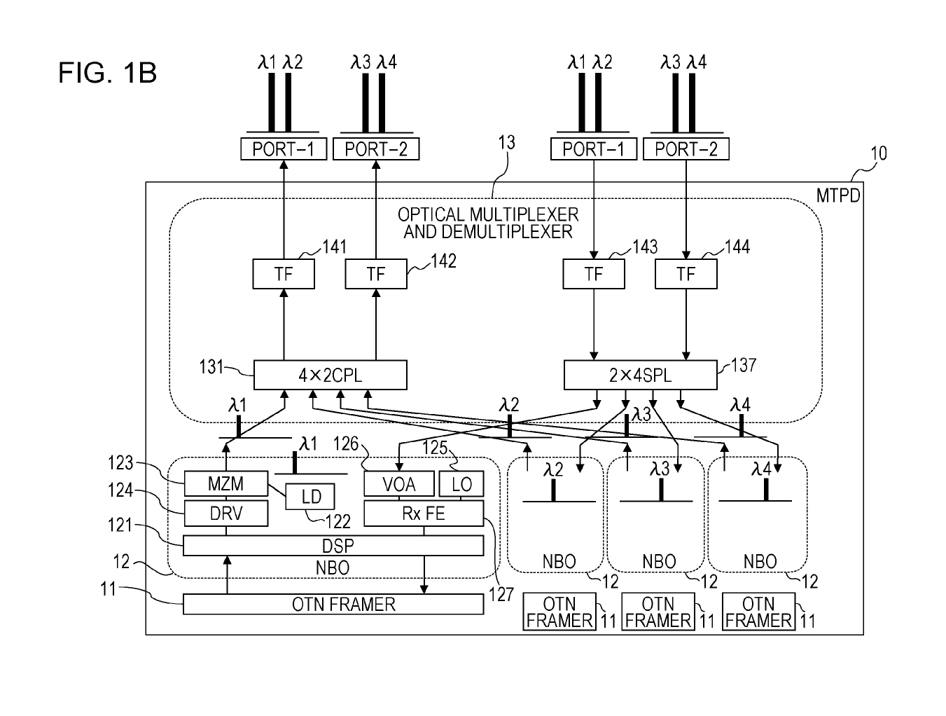

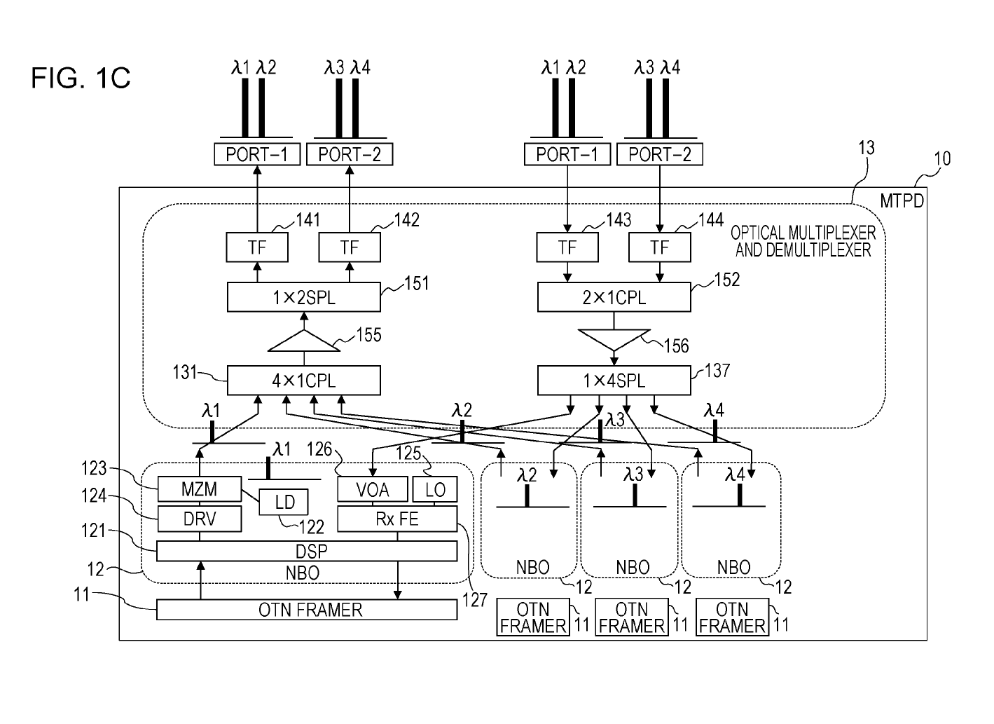

FIGS. 1A to 1C are block diagrams illustrating configuration examples of a multi-carrier transponder (MTPD) according to an embodiment.

A MTPD 10 illustrated in FIG. 1A includes, for example, N sets of optical transport network (OTN) framers 11 and subcarrier transceivers 12, and an optical multiplexer and demultiplexer 13. N is an integer of 2 or more, and N=4 in the example of FIG. 1A.

When focusing on a transmission system, the optical multiplexer and demultiplexer 13 includes, for example, an N×1 optical coupler (CPL) 131 including N input ports and one output port, and a 1×M wavelength selective switch (WSS) 132 including one input port and M output ports.

When focusing on a reception system, the optical multiplexer and demultiplexer 13 includes an M×1 wavelength selective switch 136 including M input ports and one output port, and a 1×N optical splitter (SPL) 137 including one input port and N output ports.

M is an integer of 2 or more, and corresponds to the number of output (transmission) ports or input (reception) ports of the MTPD 10. FIG. 1A illustrates an example in which M=2, that is, the number of transmission ports of the MTPD 10 and the number of reception ports thereof are respectively two.

These ports may be respectively connected to transmission and reception (or input and output) ports of an optical transmitter such as a reconfigurable optical add/drop multiplexer (ROADM) to be described below by using, for example, individual optical fibers. For example, add ports of the ROADM may be connected to the transmission ports of the MTPD 10, and drop ports of the ROADM may be connected to the reception ports of the MTPD 10.

The add port is an example of an input port to which light to be added to a main optical signal transmitted from the ROADM is input. The drop port is an example of an output port from which light dropped from the main optical signal transmitted from the ROADM is output.

The OTN framer 11 processes a transmission signal (referred to as a “client signal”) such as an Ethernet (trademark) signal, a synchronous digital hierarchy (SDH) signal, or a synchronous optical network (SONET) signal. A network in which the client signal is transmitted is referred to as a client network or a tributary network.

For example, the OTN framer 11 converts a client signal received from the tributary network into an OTN frame signal, and transmits the converted OTN frame signal to the subcarrier transceiver 12. The OTN framer 11 converts an OTN frame signal received from the subcarrier transceiver 12 into a client signal, and transmits the converted client signal into the tributary network. Signal conversion between the OTN frame signal and the client signal may be referred to as format conversion, or may be referred to as mapping or demapping.

The subcarrier transceiver 12 modulates light having a certain wavelength by using the OTN frame signal received from the OTN framer 11, and outputs the modulated optical signal to one of the four input ports of the 4×1 optical coupler 131. The subcarrier transceiver 12 demodulates a modulated optical signal having a certain wavelength received from the 1×4 optical splitter 137, and transmits the demodulation optical signal to the OTN framer 11. The subcarrier transceiver 12 may be referred to as a narrow band optical block (NBO) module (or block) 12.

The “wavelength” may be referred to as a “channel” or a “carrier”. A channel group in which a plurality of channels groups together may be referred to as a “super-channel”. “Super-channel” transmission is an example of multi-carrier transmission, and a carrier which is an element of the super-channel may be a “subcarrier”. The multi-carrier transmission is one technology of enabling large-capacity transmission such as 400 gigabits/second (Gbps) or 1 terabit/second (Tbps) by transmitting the plurality of subcarriers as a group.

In the MTPD 10 illustrated in FIG. 1A, each of the four NBO modules 12 processes light having one transmission wavelength or one reception wavelength, and any of four wavelengths (carriers) λ1 to λ4 may correspond to a subcarrier. The four subcarriers (λ1 to λ4) may be elements of one super-channel, or some or all of the four subcarriers may be elements of different super-channels. Optical signals of subcarriers constituting one super-channel may be optical signals transmitted to the same destination. Note that an aspect in which optical signals of different subcarriers are transmitted to different destinations may not be excluded.

The subcarrier transceiver 12 includes, for example, a digital signal processor (DSP) 121, a light source 122, an optical modulator 123, and a modulator driver (drive circuit) 124. The subcarrier transceiver 12 includes a local oscillation light source (LO) 125, a variable optical attenuator (VOA) 126, and a light receiving front-end (Rx FE) 127. The light receiving front-end 127 includes, for example, a coherent optical receiver. Thus, hereinafter, the light receiving front-end 127 is conveniently referred to as a coherent optical receiver 127.

The DSP 121, the light source 122, the optical modulator 123, and the modulator driver 124 constitute an example of an optical transmission unit or an optical transmitter. The DSP 121, the local oscillation light source 125, the VOA 126, and the light receiving front-end 127 constitute an example of an optical reception unit or an optical receiver.

The DSP 121 performs digital signal processing, is an example of a processor having arithmetic capacity, and performs digital signal processing such as waveform shaping on the transmission or reception OTN frame signal. For example, the digital signal processing is performed on the signal received from the OTN framer 11 by the DSP 121, and the processed signal is input to the modulator driver 124. The signal input to the modulator driver 124 from the DSP 121 may be referred to as a “transmission data signal”. Meanwhile, the digital signal processing is performed on the signal received from the light receiving front-end 127 in the DSP 121, and the processed signal is transmitted to the OTN framer 11.

The light source 122 is, for example, a laser diode (tunable LD) in which an emission wavelength (referred to as a “transmission wavelength”) is a variable wavelength. For example, light (continuous light) which is continuously output from the light source 122 is input to the optical modulator 123. The emission wavelength may be set by the DSP 121.

The modulator driver 124 generates a drive signal of the optical modulator 123 in response to the transmission data signal input from the DSP 121, and inputs the drive signal to the optical modulator 123.

The optical modulator 123 is, for example, a Mach-Zehnder modulator (MZM) which is an example of an external modulator. The Mach-Zehnder modulator 123 generates a transmission modulation optical signal having an emission wavelength (subcarrier) of the light source 122 by modulating the continuous light from the light source 122 in response to the drive signal input from the modulator driver 124. Accordingly, the transmission modulation optical signal may be referred to as a subcarrier modulation optical signal.

The modulation format in the optical modulator 123 may be variable. In other words, the optical modulator 123 may support a plurality of modulation formats. As a non-limited example, quadrature phase shift keying (QPSK), quadrature amplitude modulation (QAM), dual polarization (DP)-QPSK, or DP-QAM may be applied to the modulation format.

The modulation format may be changed by changing digital signal processing such as symbol mapping in, for example, the DSP 121 to change the drive signal applied to the optical modulator 123. A subcarrier modulation optical signal having a format corresponding to the modulation format by applying the drive signal depending on the modulation format to the optical modulator 123 is generated by the optical modulator 123. Accordingly, the modulation format being variable means that the drive signal applied to the optical modulator is variable.

The subcarrier modulation optical signal is guided to one of the four input ports of the 4×1 optical coupler 131. Subcarrier modulation optical signals generated by the three other subcarrier transceivers 12 are respectively input to the three other input ports of the 4×1 optical coupler 131. In other words, the 4×1 optical coupler 131 multiplexes the subcarrier modulation optical signals that are respectively generated in the four subcarrier transceivers 12.

The 1×2 WSS 132 is an example of an optical device capable of selectively outputting the modulation optical signals multiplexed in the 4×1 optical coupler 131 to any of two output ports in a unit of a wavelength (subcarrier). For example, the 1×2 WSS 132 may output all of the four subcarrier modulation optical signals to one output port, or may output some subcarrier modulation optical signals to one output port and may output the remaining subcarrier modulation optical signals to the other output port.

The 4×1 optical coupler 131 and the 1×2 WSS 132 constitute an example of a wavelength selection unit that selects any of the two transmission ports of the MTPD 10, and outputs the subcarrier modulation optical signals generated by the plurality of NBO modules 12 in which the modulation format is variable to the selected port in a unit of the wavelength.

For example, the 2×1 WSS 136 is an example of an optical device capable of outputting subcarrier modulation optical signals input to any of two input ports to an output port in a unit of the wavelength (subcarrier).

The 1×4 optical splitter 137 is an example of an optical device capable of branching the subcarrier optical signals input from the output port of the 2×1 WSS 136 into four. The four branched light waves are respectively guided (distributed) to the VOAs 126 of the four NBO modules 12 one by one.

The 2×1 WSS 136 and the 1×4 splitter 137 constitute an example of an optical multiplexer and demultiplexer that multiplexes or demultiplexes the optical signals input to the two reception ports of the MTPD 10 in a unit of the wavelength. The first input port corresponds to a first degree, and one or a plurality of first subcarrier modulation optical signals modulated using a variable modulation format modulated by a set of an optical modulator and a driver is input to the first input port. The second input port corresponds to a second degree, and one or a plurality of second subcarrier modulation optical signals modulated using a variable modulation format is input to the second input port.

In the reception unit of the NBO module 12, the local oscillation light source 125 generates local oscillation light used for coherent reception in the coherent optical receiver 127. A tunable LD may be used as the local oscillation light source 125. A wavelength of the local oscillation light may be set (controlled) depending on a wavelength (referred to as a “reception subcarrier”) of the subcarrier modulation optical signal to be received (demodulated). The reception subcarrier may be set by, for example, the DSP 121.

The VOA 126 adjusts input light (reception light) power to the coherent optical receiver 127 by controlling an attenuation amount of light (subcarrier modulation optical signal which is an example of reception light) input from one of the output ports of the 1×4 optical splitter 137. The attenuation amount of the VOA 126 may be referred to as a “VOA loss”.

For example, the VOA loss is set (controlled) such that the light power input to the coherent optical receiver 127 falls within a predetermined allowable reception range. The VOA loss may be controlled by, for example, the DSP 121.

The coherent optical receiver 127 allows the local oscillation light from the local oscillation light source 125 to interfere in received light which is the output light of the VOA 126, and extracts strength information and phase information of the received subcarrier modulation optical signal (performs coherent reception). The extracted strength information and phase information are used for the digital signal processing in the DSP 121. For example, the DSP 121 performs compensation for transmission line distortion (waveform distortion) using the digital signal processing on the received signal based on the strength information and phase information of the received signal, and demodulates the received signal. The demodulated signal is input to the OTN framer 11.

However, as described above, in each of the N(=4) NBO modules 12, the modulation format is variable. Thus, the MTPD 10 may transmit and receive optical signals of various transmission rates (may be referred to as transmission capacity) and modulation formats by combining the modulation formats for the N subcarriers.

As a non-limited example, it is assumed that the four NBO modules 12 respectively transmit and receive DP-QPSK optical signals of 100 Gbps as the subcarrier modulation optical signals. In this case, the MTPD 10 may transmit and receive the DP-QPSK optical signals of 100 Gbps×4 (subcarriers)=400 Gbps. The four subcarriers may constitute the super-channel. This case is conveniently referred to as a “case 1”, and the modulation format in the case 1 is conveniently referred to as a “400 G super-channel format #1” or “400 G format #1”.

Two of the four NBO modules 12 may respectively transmit and receive DP-16QAM optical signals of 200 Gbps as the subcarrier modulation optical signals. In this case, the MTPD 10 may transmit and receive the DP-16QAM optical signals of 200 Gbps×2 subcarriers=400 Gbps. The two subcarriers may constitute the super-channel. This case is conveniently referred to as a “case 2”, and the modulation format in the case 2 is conveniently referred to as “400 G super-channel format #2” or “400 G format #2”.

Three of the four NBO modules 12 may respectively transmit and receive DP-8QAM optical signals of 150 Gbps as the subcarrier modulation optical signals. This case is conveniently referred to as a “case 3”. The three subcarriers may constitute the super-channel. The modulation format in the case 3 is conveniently referred to as “400 G super-channel format #3” or “400 G format #3”.

Here, in the case 2 or the case 3, there is an unused NBO module 12 in the MTPD 10. The unused NBO module 12 may use to transmit and receive another optical signal so as not to be wasted.

For example, in the case 2, since the two NBO modules 12 remain, these two NBO modules 12 may transmit and receive, for example, DP-16QAM optical signals of 200 Gbps×2 subcarriers=400 Gbps. The two subcarriers may constitute another super-channel. In this case, the MTPD 10 may transmit and receive the DP-16QAM optical signal of 200 Gbps in each of the four subcarriers. This case is conveniently referred to as a case 4.

In the case 3, since one NBO module 12 remains, the remaining NBO module 12 may transmit and receive, for example, DP-QPSK optical signals of 100 Gbps. In this case, the MTPD 10 may transmit and receive the DP-8QAM optical signal of 150 Gbps in each of the three subcarriers, and may transmit and receive the DP-QPSK optical signal of 100 Gbps in one subcarrier. This case is conveniently referred to as a case 5.

As mentioned above, since the remaining NBO module 12 may use to transmit and receive an optical signal of another new super-channel or an optical signal of a single channel, it is possible to effectively use the NBO modules 12.

One NBO module 12 has, for example, transmission capacity of about 100 Gbps to about 200 Gbps, and is an expensive functional block. Accordingly, since the remaining NBO module 12 is used to generate additional optical signals as in the case 4 or the case 5, it is possible to effectively the NBO modules 12 with good cost performance.

As stated above, since each NBO module 12 supports a plurality types of modulation formats, it is possible to freely change the modulation format depending on a usage condition of resources such as a frequency or a transmission distance of the optical signal.

For example, in view of frequency usage efficiency, the case 2 or the case 3 (400 Gbps super-channel of the QAM optical signals) may further improve the frequency usage efficiency as compared to the case 1 (400 Gbps super-channel of the DP-QPSK optical signal×4 wavelengths). In view of the transmission distance, the case 1 may further expand the transmission distance as compared to the case 2 or the case 3.

However, as illustrated in FIG. 1A, since the WSSs 132 and 136 are included in the optical multiplexer and demultiplexer 13 of the MTPD 10, it is possible to transmit and receive (add/drop) the optical signal to and from the degrees that are supported by the ROADM in a unit of the subcarrier modulation optical signal.

For example, the MTPD 10 may selectively output add light to any of the optical fibers in a unit of the subcarrier, and by connecting the M output ports of the 1×M WSS 132 to, for example, the add ports of the ROADM by using the individual optical fibers.

The ROADM may selectively receive drop light through the optical fibers in a unit of the subcarrier by connecting the M input ports of the M×1 WSS 136 to, for example, the drop ports of the ROADM by using the individual optical fibers.

Accordingly, the MTPD 10 may selectively transmit and receive light to and from the ROADM for each optical fiber used to be connected to the ROADM in a unit of the subcarrier (in other words, in a unit of the NBO module 12). As will be specifically described below, the MTPD 10 may selectively transmit and receive light for each degree supported by the ROADM in a unit of the subcarrier.

For example, it is assumed that the remaining NBO module 12 is used to transmit and receive the optical signal of the another new super-channel or the optical signal of the single channel in as in the case 4 or the case 5. In this case, the optical signal of the new super-channel or the single channel may be transmitted or received through another degree different from the degree of the optical signal of another super-channel or the single channel.

FIG. 1B describes a modification example of the configuration of the optical multiplexer and demultiplexer 13 described in FIG. 1A. An optical multiplexer and demultiplexer 13 of FIG. 1B includes a 4×2 coupler 131 including four ports which receive signal light waves from the four NBO modules 12 and two ports which multiplex the signal light waves input from the four ports to output the multiplexed signal light waves. For example, a tunable filter 141 selects signal light waves having wavelengths λ1 and λ2 of the signal light waves output from the two ports, and outputs the signal light waves having the selected wavelengths to a PORT-1. A tunable filter 142 selects signal light waves having wavelengths λ3 and λ4, and outputs the signal light waves having the selected wavelengths to a PORT-2. One or a plurality of tunable filters 141 and 142 may be provided in parallel such that one or a plurality of variable wavelength bands that transmits a plurality of wavelengths is provided and a signal light wave having an arbitrary wavelength is selected. In such a configuration, it is possible to select any of the PORT 1 and the PORT 2, and to transmit the signal light waves having the wavelengths of the signal light waves λ1 to λ4 output from the four NBO modules 12 to the selected port.

Similarly, signal light waves having wavelengths to be transmitted are selected from the signal light waves input from a PORT-1 and a PORT-2 on an input side through tunable filters 143 and 144 having the same configurations as those of the tunable filters 141 and 142. The tunable filters 141 and 142 may not have the same configurations as those of the tunable filters 143 and 144. The signal light waves having the wavelengths λ1, λ2, λ3, and λ4 selected in the tunable filters 143 and 144 are distributed to the NBO modules 12 by being branched into four in a 2×4 splitter 137. In such a configuration, it is possible to arbitrarily select the signal light waves having any of the wavelengths λ1 to λ4 from the signal light waves input to the PORT-1 or the PORT-2 on the input side through the tunable filters 143 and 144, and to transmit the signal light waves having the selected wavelengths to any of the four NBO modules 12.

FIG. 1C describes a modification example of the configuration of the optical multiplexer and demultiplexer 13 described in FIG. 1B. In FIG. 1C, an optical multiplexer and demultiplexer includes a 4×1 optical coupler that includes four ports which receive optical signals λ1 to λ4 output from the four NBO modules 12 in order to multiplex the received optical signals, and one port which outputs the multiplexed optical signals. The optical signals from the output port are amplified in an optical amplifier 155, and are input to a 1×2 splitter 151. FIG. 1C is different from FIG. 1B in that optical signals output from the 1×2 splitter 151 are input to tunable filters 141 and 142. FIG. 1C is different from the aforementioned description in that optical signals input from the PORT-1 and the PORT-2 on the input side propagates in a reverse direction. The optical multiplexer and demultiplexer includes tunable filters 143 and 144, a 2×1 coupler 152, an optical amplifier 156, and a 1×4 splitter 137. The tunable filters 143 and 144 select optical signals having desired wavelengths from input optical signals, and output the selected optical signals. The output optical signals having the desired wavelengths are input to two ports of the 2×1 coupler 152, and are multiplexed. The multiplexed optical signals are distributed to the four NBO modules 12 through four ports. In the aforementioned configuration, since the 1×2 splitter 151 and the 4×1 coupler 131, and the 1×4 splitter 137 and the 2×1 coupler 152 have one port respectively, the desired number of relatively expensive optical amplifiers may be reduced up to two.

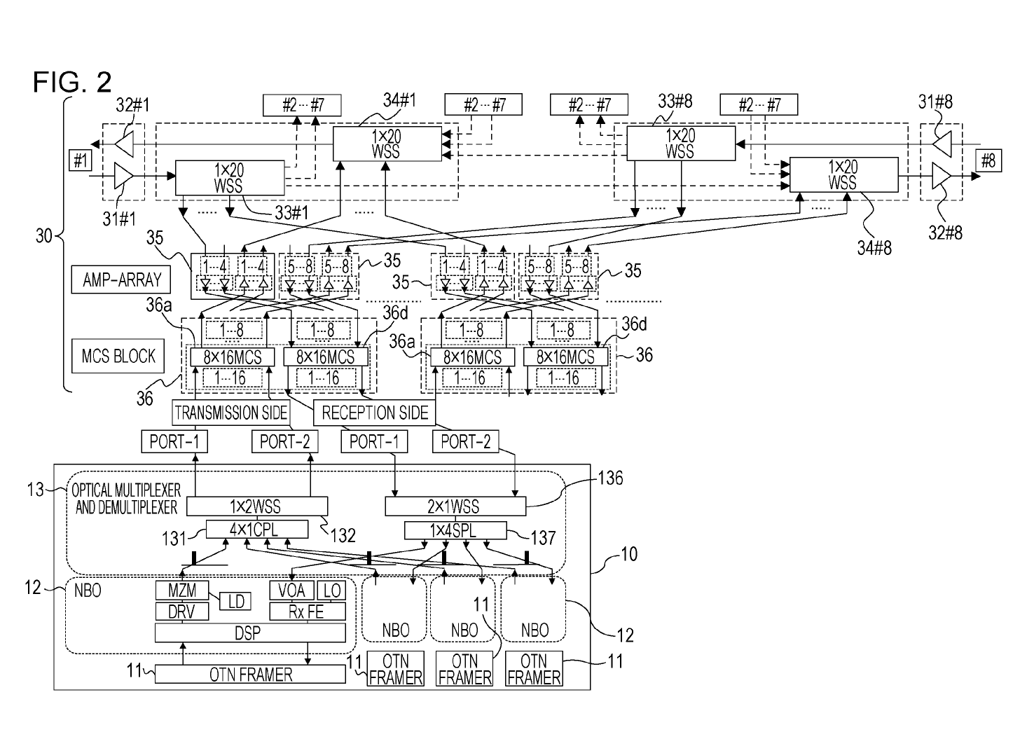

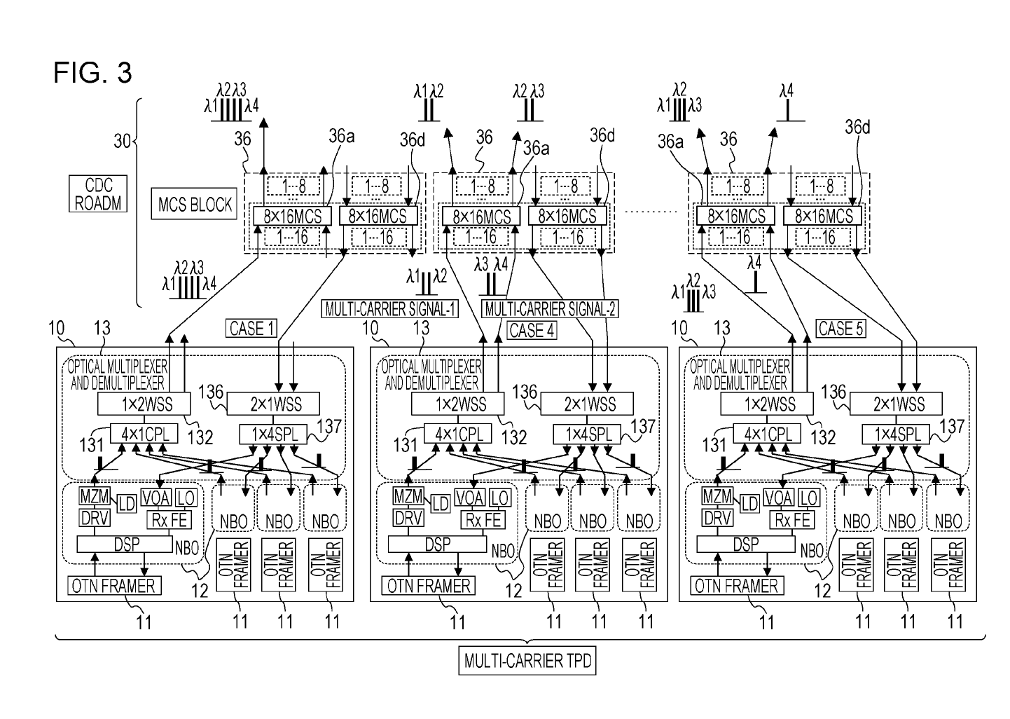

A configuration example in which the MTPD 10 illustrated in FIGS. 1A to 1C is connected to a ROADM 30 will be described with reference to FIGS. 2 and 3. The ROADM 30 is an example of an optical transmitter used for, for example, a wavelength-division multiplexing (WDM) optical transmission system, and the ROADM 30 may insert optical signals to an optical transmission line in a unit of the wavelength, and extract optical signals from the optical transmission line in a unit of the wavelength.

The ROADM 30 may have three functions (CDC functions) called colorless (wavelength independence), directionless (direction independence), and contentionless (the same wavelength contentionless). The ROADM 30 having the CDC functions may be referred to as a CDC ROADM 30.

The colorless means a configuration and a function capable of inputting an arbitrary wavelength to an arbitrary port of the ROADM 30 and outputting an arbitrary wavelength from an arbitrary port. The directionless means a configuration or a function of guiding optical signals from the respective terminal stations to an arbitrary degree in a configuration in which the ROADM 30 supports a plurality of degrees and guiding optical signals from the respective degrees to an arbitrary terminal station. The contentionless means a configuration or a function of avoiding contention of optical signals having the same wavelength within the ROADM 30.

The ROADM 30 illustrated in FIG. 2 is an example of the CDC ROADM, and supports, for example, 8 degrees (Degrees #1 to #8). Each of the degrees #1 to #8 may include a set of an input degree and an output degree. Each of the input degree and the output degree is an optical transmission line using, for example, an optical fiber.

The ROADM 30 includes, for example, optical amplifiers 31 and 32, and 1×20 WSSs 33 and 34 which are respectively provided at the respective degrees #1 to #8. For example, the optical amplifiers 31#1 and 32#1, and the 1×20 WSSs 33#1 and 34#1 are provided so as to correspond to the degree #1. Similarly, the optical amplifiers 31#8 and 32#8, and the 1×20 WSSs 33#8 and 34#8 are provided so as to correspond to the degree #8. In FIG. 2, the optical amplifiers 31 and 32, and the 1×20 WSSs 33 and 34 which correspond to the degrees #2 to #7 are not illustrated.

The ROADM 30 includes, for example, optical amplifier array blocks 35, and multicast switch (MCS) blocks 36 so as to correspond to the degrees #1 to #8. The optical amplifier array blocks 35 and the MCS blocks 36 are provided by the number corresponding to add wavelength numbers and drop wavelength numbers of the respective degrees #1 to #8. The details will be described below.

The optical amplifier 31#1 amplifies a WDM optical signal input from the degree #1, and outputs the amplified signal to the 1×20 WSS 33#1.

The optical amplifier 31#8 amplifies a WDM optical signal input from the degree #8, and outputs the amplified signal to the 1×20 WSS 33#8.

The optical amplifier 32#1 amplifies an optical signal input from the 1×20 WSS 34#1, and outputs the amplified signal to an output degree of the degree #1.

The optical amplifier 32#8 amplifies an optical signal input from the 1×20 WSS 34#8, and outputs the amplified signal to an output degree of the degree #8.

The 1×20 WSS 33#1 selectively outputs the WDM optical signal input from the optical amplifier 31#1 of the degree #1 to any of 20 output ports in a unit of the wavelength.

For example, any of the degrees #2 to #7, the 1×20 WSS 33#8 corresponding to the degree #8, and any of the optical amplifier array blocks 35 are optically connected to any of the 20 output ports. The optical connection may be performed using an optical fiber. The remaining output ports may not be used.

Accordingly, the WDM optical signal received from the degree #1 is selectively output to any of the degrees #2 to #7, the 1×20 WSS 33#8 corresponding to the degree #8, or any of the optical amplifier array blocks 35 in a unit of the wavelength.

The 1×20 WSS 33#8 selectively outputs the WDM optical signal input from the optical amplifier 31#8 of the degree #8 to any of the 20 output ports in a unit of the wavelength.

For example, any of the degrees #2 to #7, the 1×20 WSS 34#1 corresponding to the degree #1, and any of the optical amplifier array blocks 35 are optically connected to any of the 20 output ports. The optical connection may be performed using an optical fiber. The remaining output ports may not be used.

Accordingly, the WDM optical signal received from the degree #8 is selectively output to any of the degrees #2 to #7, the 1×20 WSS 34#1 corresponding to the degree #1, or any of the optical amplifier array blocks 35 in a unit of the wavelength.

Light that is selectively output to any of the optical amplifier array blocks 35 from the 1×20 WSS 33 corresponds to drop light to the MTPD 10.

An optical signal from any of the degrees #2 to #7, output light of the 1×20 WSS 33#8, and output light from any of the optical amplifier array blocks 35 are optically connected to any of the 20 input ports of the 1×20 WSS 34#1. One output port of the 1×20 WSS 34#1 is optically connected to the optical amplifier 32#1 of the degree #1. The optical connection may be performed using an optical fiber. Any of the 20 input ports may not be used.

Accordingly, the 1×20 WSS 34#1 selectively outputs the optical signal from any of the degrees #2 to #7, the output light of the 1×20 WSS 33#8, or the output light from any of the optical amplifier array block 35 to one output port in a unit of the wavelength. The output port is connected to the optical amplifier 32#1 provided at the output degree of the degree #1.

The optical signal from any of the degrees #2 to #7, the output light of the 1×20 WSS 33#1, and the output light from any of the optical amplifier array blocks 35 are optically connected to any of the 20 input ports of the 1×20 WSS 34#8. One output port of the 1×20 WSS 34#8 is optically connected to the optical amplifier 32#8 of the degree #8. The optical connection may be performed using an optical fiber. Any of the 20 input ports may not be used.

Accordingly, the 1×20 WSS 34#8 selectively outputs the optical signal from any of the degrees #2 to #7, the output light from the 1×20 WSS 33#1, or the output light from any of the optical amplifier array blocks 35 to one output port in a unit of the wavelength. The output port is connected to the optical amplifier 32#8 provided at the output degree of the degree #8.

The light input to the 1×20 WSS 34 from any of the optical amplifier array blocks 35 corresponds to add light.

In FIG. 2, for example, eight optical amplifier array blocks 35 are provided so as to correspond to the number of the degrees #1 to #8. In order to compensate for insertion loss of the MCS block 36, the optical amplifier array block 35 amplifies the add light transmitted from the MTPD 10 or the drop light received by the MTPD 10.

Thus, each of the optical amplifier array blocks 35 includes, for example, add optical amplifiers of the number corresponding to the number of add wavelengths, and drop optical amplifiers of the number corresponding to the number of drop wavelengths. For example, FIG. 2 illustrates that two add optical amplifiers and two drop optical amplifiers are provided for one optical amplifier array block 35. Accordingly, eight optical amplifier array blocks 35 include optical amplifiers corresponding to 32 wavelengths (=eight degrees of the degrees #1 to #8×(two add wavelengths+two drop wavelengths)) in total.

The optical amplifiers corresponding to the 32 wavelengths are connected to two MCS blocks 36 including 16 ports each including 8 add output ports and 8 drop input ports in total. For example, the MCS blocks 36 includes an 8×16 MCS 36a corresponding to add wavelengths, and an 8×16 MCS 36d corresponding to drop wavelengths.

The 8 output ports of the 8×16 MCS 36a are connected to, for example, any of the add optical amplifiers constituting the optical amplifier array block 35. The 8 input ports of the 8×16 MCS 36d are connected to, for example, any of the drop optical amplifiers constituting the optical amplifier array block 35.

For example, two output ports of the MTPD 10 (1×2 WSS 132) are connected to any of 16 input ports of the 8×16 MCS 36a. For example, two input ports of the MTPD 10 (2×1 WSS 136) are connected to any of 16 output ports of the 8×16 MCS 36d.

The MCS blocks 36 and the aforementioned 1×20 WSSs 33 and 34 constitute an example of a degree selection unit that selects optical signals transmitted to the degrees #1 to #8 in a unit of the wavelength.

The MCS block 36 may be referred to as a transponder aggregator (TPA) block aggregation (or accommodation) block for connecting (referred to as aggregating or accommodating) a plurality of transponders (TPDs) to the ROADM 30. It is possible to realize the aforementioned CDC by using non-blocking optical cross-connect (OXC) or wavelength selective switch (WSS) as the TPA block.

When the non-blocking optical cross-connect (OXC) or the wavelength selective switch (WSS) is used for the TPA block, as the number of accommodated TPDs is increased, the scale of the TPA block is increased, and thus, it is easy to increase price. There are many problems occurring when the device is put to practical use.

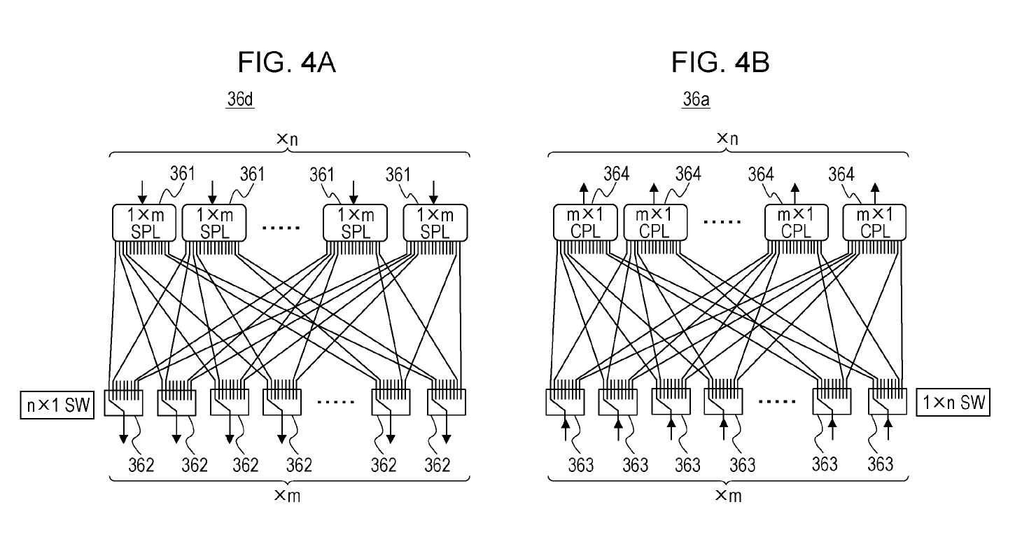

As will be described below with reference to FIGS. 4A and 4B, in the present embodiment, the device (MCS block 36) which is called the MCS and is integrated by combining the optical splitter (SPL) and the optical switch may be used as the TPA block. Since the MCS block 36 is used as the TPA block, it is possible to realize the CDC functions with the smaller-size and cheaper-price MCS block than when the expensive non-blocking OXC or WSS is used.

In the MCS block 36 of the present embodiment, the 8×16 MCS 36a multicasts the add light waves (in other word, transmission subcarrier modulation optical signals) from the MTPD 10 which are input to any of the 16 input pots to the 8 output ports.

In contrast, the 8×16 MCS 36d multicasts the drop light waves to the MTPD 10 (in other word, reception subcarrier modulation optical signals) which are input to any of the 8 input ports to the 16 output ports.

FIG. 4A illustrates a configuration example of an n×m MCS 36d for drop, and FIG. 4B illustrates a configuration example of an n×m MCS 36a for add. The n and m are integers of 2 or more, and in the example described in FIG. 2, n=8, and m=16.

As illustrated in FIG. 4A, the n×m MCS 36d for drop may be configured by combining an n number of 1×m optical splitters (SPLs) 361 and a m number of n×1 optical switches (SWs) 362. For example, an m number of output ports of the 1×m optical splitters 361 are optically connected (line-connected) to another m number of n×1 optical switches (SWs) 362. Thus, the n×m MCS 36d branches input light (drop light) into an m number in the 1×m optical splitter 361, and any of branched light waves are selectively output to any of the n×1 optical switches (SWs) 362.

Meanwhile, as illustrated in FIG. 4B, the n×m MCS 36a for add may be configured by combining an m number of 1×n optical switches 363 and an n number of M×1 optical couplers (CPLs) 364. For example, an n number of output ports of the m number of 1×n optical switches are optically connected (line-connected) to another n number of m×1 optical couplers 364. Thus, the n×m MCS 36a selectively outputs input light waves (add light) to any of the n number of m×1 optical couplers 364 in the 1×n optical switches 363, and multiplexes the output light waves in the m×1 optical couplers 364 to output the multiplexed light waves.

In the MTPD 10, when focusing on the transmission system (add system), the subcarrier modulation optical signals generated by the NBO modules 12 are multiplexed in the 4×1 optical couplers 131, and are selectively output to any of the two output ports by the 1×2 WSSs 132 in a unit of the wavelength (subcarrier).

The add light output from one or both of the two output ports is input to any of the 1×20 WSSs 34 for each of the degrees #1 to #8 after passing the 8×16 MCS blocks 36 and the optical amplifier array blocks 35, and is output to any of the degrees #1 to #8.

In other words, since the MTPD 10 includes the WSS 132 in the optical multiplexer and demultiplexer 13, one or the plurality of first subcarrier modulation optical signals, and one or the plurality of second subcarrier modulation optical signals may be selectively introduced to the same or different degree supported by the ROADM 30. In other words, the MTPD 10 may freely change the number of subcarriers for each degree.

For example, as illustrated in FIG. 3, in the aforementioned case 1, the MTPD 10 may transmit (add) the subcarrier modulation optical signals having the four wavelengths (λ1 to λ4) which are generated in the four NBO modules 12 and constitute one super-channel to the same degree (for example, degree #1).

In the aforementioned case 4, the MTPD 10 may transmit the modulation optical signals which are generated in two sets of two NBO modules 12 and constitute two super-channels (multi-carriers) to different degrees in a unit of the super-channel. For example, the modulation optical signals having two wavelengths λ1 and λ2 constituting a first super-channel may be transmitted to a first degree #1, and the modulation optical signals having two wavelengths λ3 and λ4 constitute a second super-channel may be transmitted to a second degree #8.

In the aforementioned case 5, the MTPD 10 may transmit the modulation optical signals having three wavelengths which are generated in three NBO modules 12 and constitute one super-channel, and the modulation optical signal having a signal wavelength generated in one NBO module 12 to different degrees. For example, the modulation optical signals having three wavelengths λ1 to λ3 constituting one super-channel may be transmitted to the first degree #1, and the modulation optical signal having a single wavelength λ4 may be transmitted to the second degree #8.

Meanwhile, when focusing on the reception system (drop system) of the MTPD 10, the MTPD 10 performs wavelength multiplexing on the subcarrier modulation optical signals dropped to the two input ports by the 2×1 WSS 136, and branches the multiplexed signals into four by the 1×4 SPL 137 to input the branched signals to the NBO modules 12.

The NBO module 12 selectively receives a subcarrier optical signal having a wavelength to be received by the coherent optical receiver 127 from signal lights including light waves having a plurality of wavelengths received from the 1×4 SPL 137.

As stated above, according to the aforementioned embodiment, since the 1×2 WSS 132 included in the optical multiplexer and demultiplexer 13 of the MTPD 10, it is possible to distribute and input the add light waves to the ROADM 30 to other input ports of the MCS block 36 connected to the WSS 34 for each degree in a unit of the subcarrier.

Accordingly, it is possible to freely distribute and add the add light waves to any of the plurality of degrees supported by the ROADM 30 in a unit of the subcarrier. In other words, it is possible to freely change the number of subcarrier modulation optical signals for each degree. Thus, even though the MTPD 10 is connected to the MCS block 36 of the ROADM 30, it is possible to realize (or maintain) the directionless (direction independence) for the subcarriers of the CDC functions.

Even though the MTPD 10 on which the NBO modules 12 capable of coping with the plurality types of modulation formats are mounted to the ROADM 30, it is possible to use and operate the NBO modules 12 so as not to be wasted while maintaining the CDC functions. Accordingly, it is possible to improve usage efficiency of the NBO module 12. As a result, it is possible to reduce costs of the WDM optical transmission system which uses the ROADM 30.

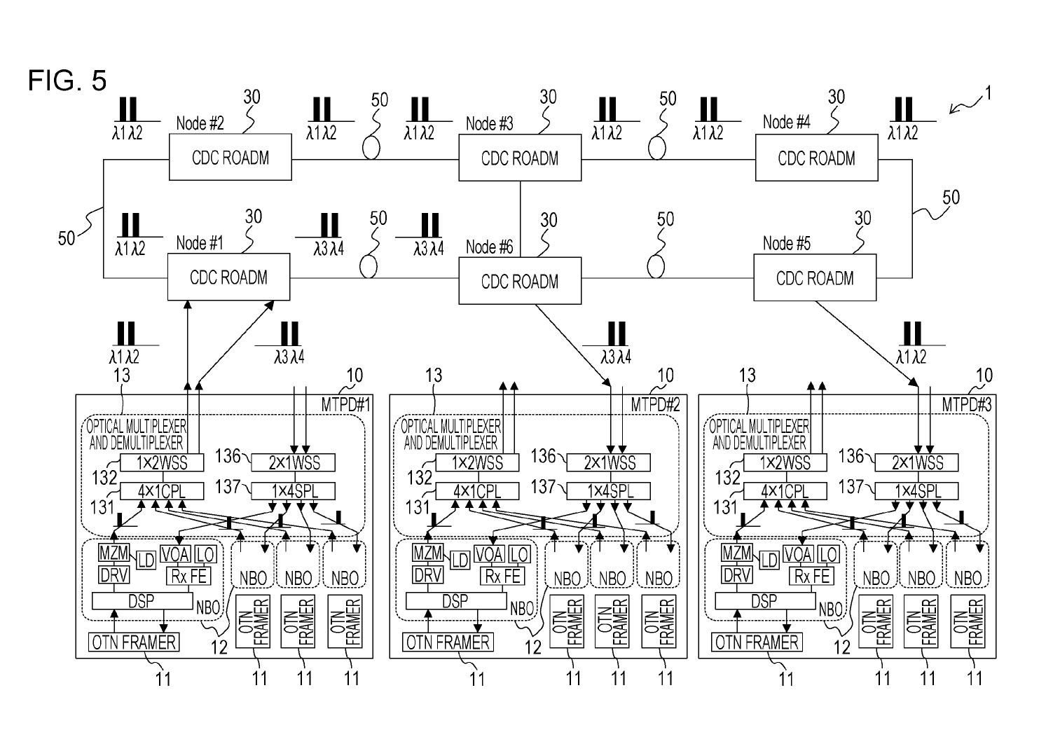

FIG. 5 illustrates a configuration example of a WDM optical transmission system including a plurality of ROADMs (CDC ROADMs) 30 having the CDC functions. A WDM optical transmission system 1 illustrated in FIG. 5 includes, for example, six (#1 to #6) ROADMs 30 (hereinafter, referred to as “ROADM nodes #1 to #6” or simply referred to as “nodes #1 to #6”).

For example, the ROADM nodes #1 to #6 are connected in a ring shape through an optical transmission line 50. The ROADM nodes #3 and #6 are connected through an optical transmission line 70. The optical transmission lines 50 and 70 are, for example, optical fiber transmission lines.

The MTPDs 10 illustrated in FIGS. 1A to 3 are respectively connected to the ROADM nodes #1, #6, and #5. Hereinafter, the respective MTPDs 10 connected to the ROADM nodes #1, #6, and #5 are described as MTPDs #1, #2, and #3.

In the WDM optical transmission system 1 illustrated in FIG. 5, the aforementioned case 4 is assumed. That is, in the MTPD #1, it is assumed that modulation optical signals which are generated in two sets of two NBO modules 12 and constitute two super-channels (multi-carriers) are guided to different degrees in a unit of the super-channel.

For example, the MTPD #1 introduces (adds) the modulation optical signals having two wavelengths λ1 and λ2 constituting the first super-channel whose destination is the node #5 to the degrees of the node #1 and the node #2 through one output port of the 1×2 WSS 132. The MTPD #1 introduces the modulation optical signals having two wavelengths λ3 and λ4 constituting the second super-channel whose destination is the node #6 to the degrees of the node #1 to the node #6 through the other output port of the 1×2 WSS 132.

Thus, the optical signals of the first super-channel are transmitted in a route passing through the nodes #1-#2-#3-#4, reach the node #5, are dropped to the 2×1 WSS 136 of the MTPD #3 in the node #5. Meanwhile, the optical signals of the second super-channel are transmitted from the node #1 to the adjacent node #6, and are dropped to the 2×1 WSS 136 of the MTPD #2 in the node #6.

Since the add light waves may be freely inserted into the degrees in a unit of the subcarriers, it is easy to control the subcarriers due to configuring (controlling) of the currently used (working) channel and the preliminary (protection) channel.

For example, since any of the above-described first and second super-channels may be currently used and the other one thereof may be preliminarily used, it is possible to easily change configuration of the subcarriers (in other words, modulation format) constituting the super-channel.

It is possible to realize such a channel configuration or modulation format configuration by controlling the emission wavelengths of the local oscillation light source 125 or the light source 122 of the NBO module 12. The emission wavelength may be controlled by, for example, a maintenance device that maintains, operates and manages the WDM optical transmission system 1 in a remote manner. Accordingly, it is possible to realize a network technology capable of freely enabling the channel configuration or modulation format configuration from a remote site on demand. As a result, for example, it is easy to secure a communication channel when a disaster or an obstruction occurs.

### COMPARATIVE EXAMPLE

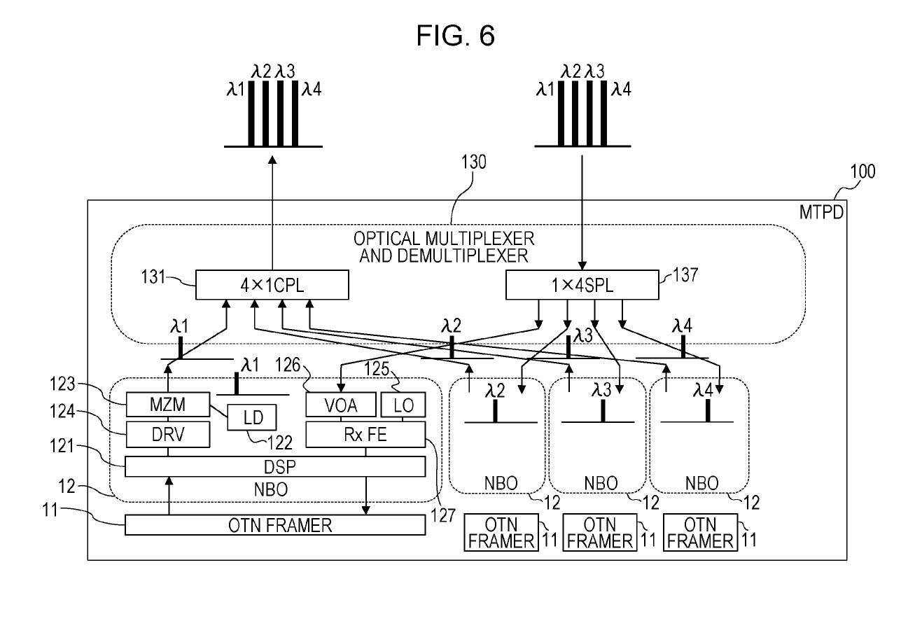

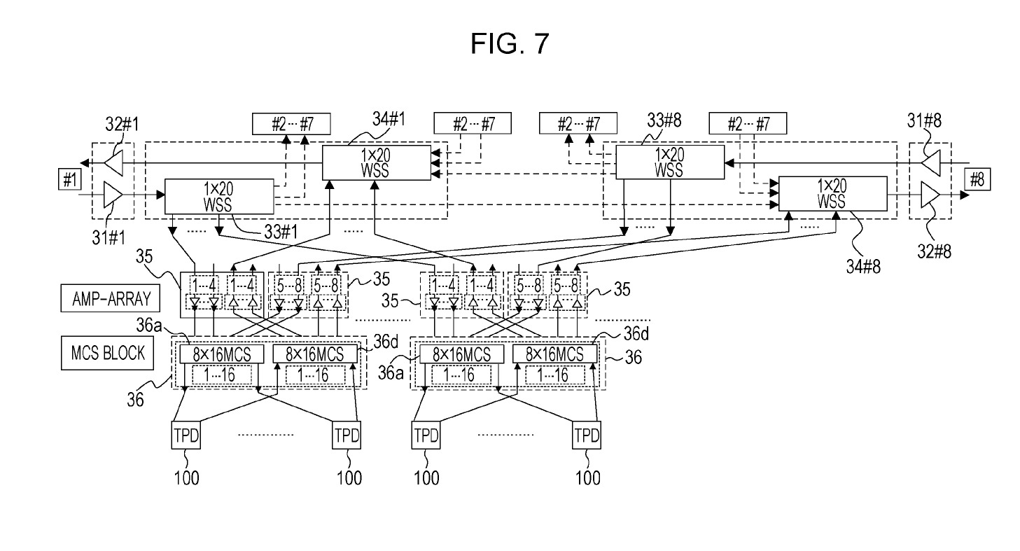

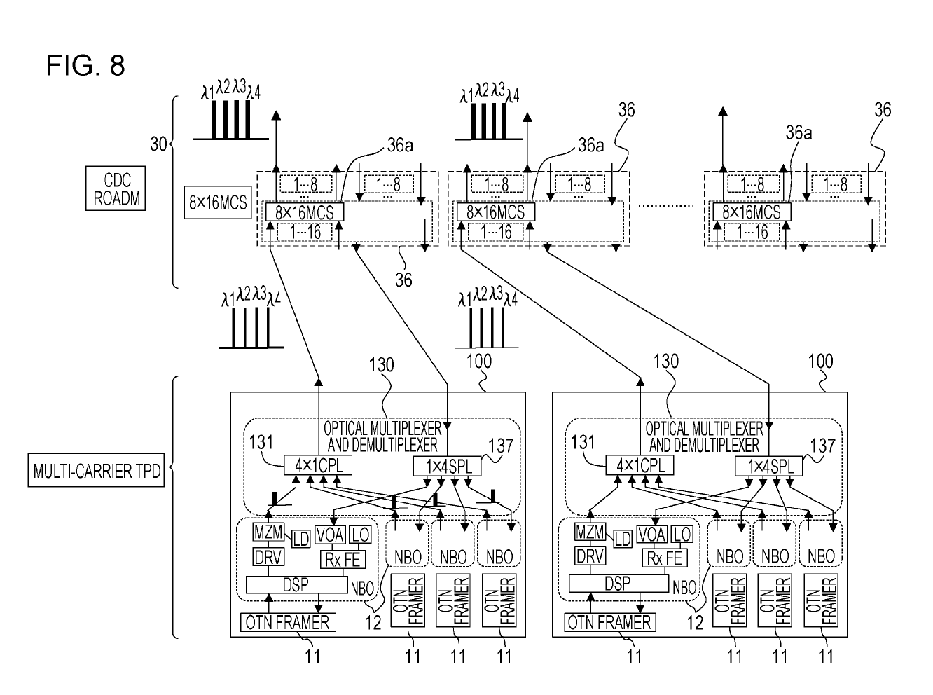

Next, a comparative example of the aforementioned embodiment will be described with reference to FIGS. 6 to 11. FIG. 6 is a block diagram illustrating a configuration example of a MTPD 100 as the comparative example of the MTPD 10 illustrated in FIGS. 1A to 1C. FIGS. 7 and 8 are diagrams illustrating a configuration example in which the MTPD 100 illustrated in FIG. 6 is connected to the ROADM 30 similarly to FIGS. 2 and 3.

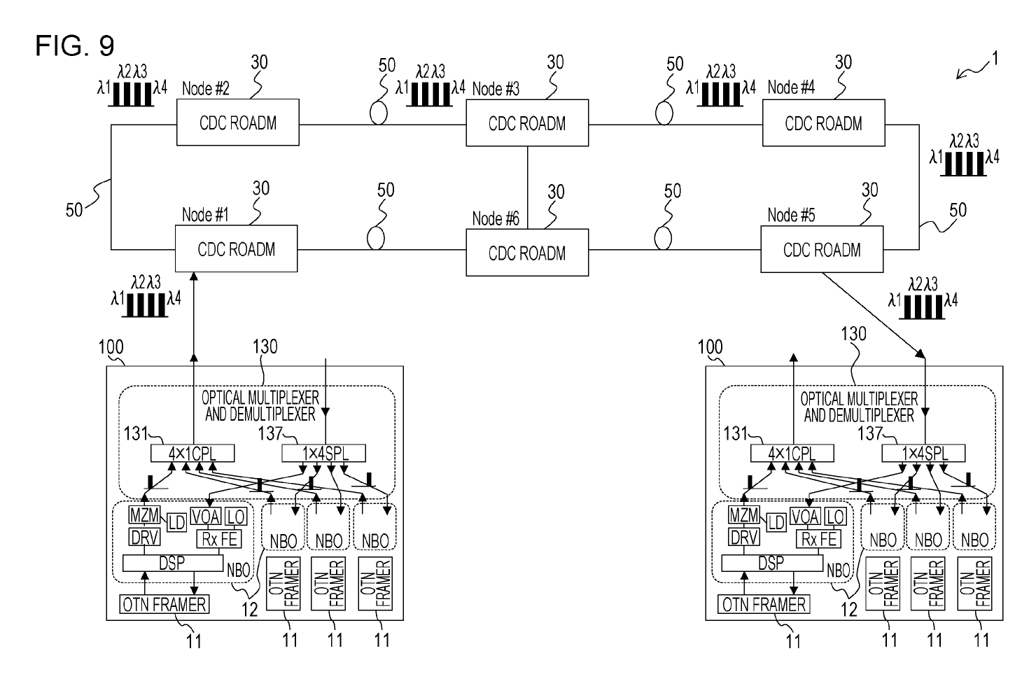

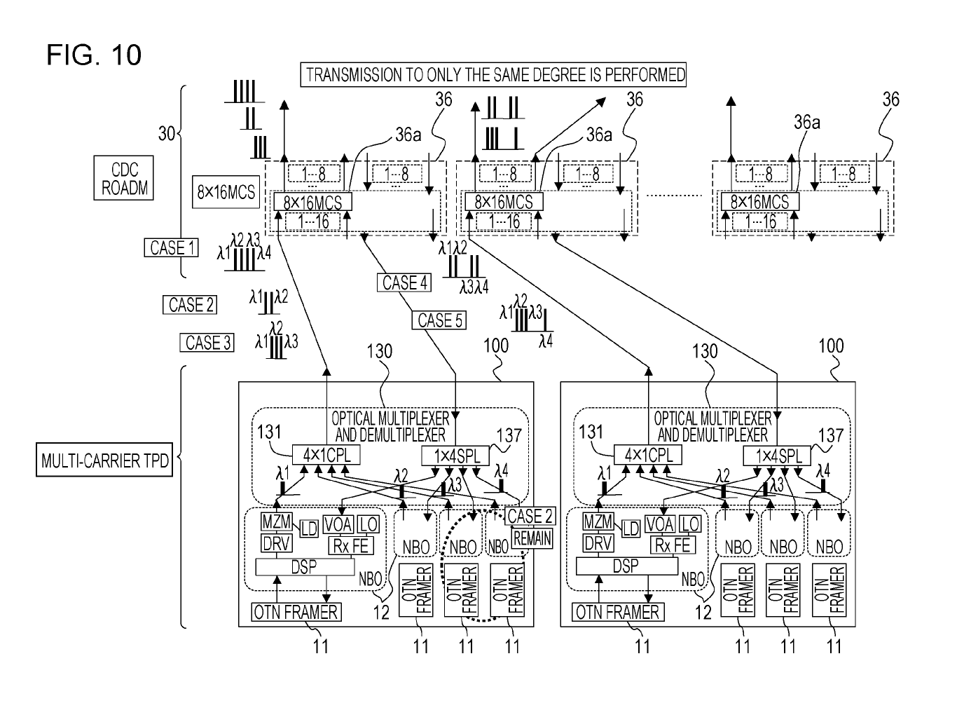

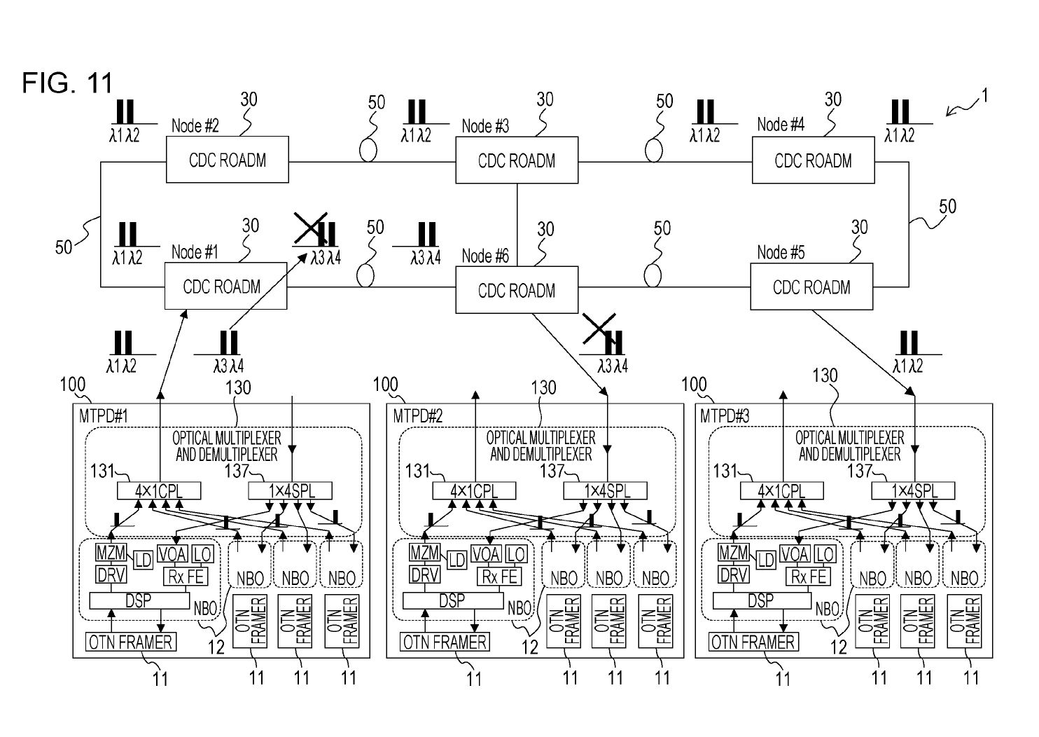

FIG. 9 is a block diagram illustrating an example in which the configuration illustrated in FIGS. 7 and 8 is applied to the WDM optical transmission system similarly to FIG. 5. FIGS. 10 and 11 are diagrams for describing that there is a case where it is difficult to freely transmit optical signals to different degrees through the ROADM in a unit of the subcarrier in the configuration illustrated in FIGS. 6 to 9.

The MTPD 100 as the comparative example illustrated in FIG. 6 has a difference from the configuration illustrated in FIG. 1A in that the 1×2 WSS 132 and the 2×1 WSS 136 are not provided in an optical multiplexer and demultiplexer 130. Thus, as illustrated in FIGS. 6 and 7, one output port of a 4×1 optical coupler 131 for add is connected to one of the input (add) ports of the MCS block 36 (8×16 MCS 36a) of the ROADM 30 by using one optical fiber for transmission (add). One input port of a 1×4 optical splitter 137 for drop is connected to one of the output (drop) ports of the MCS block 36 (8×16 MCS 36d) of the ROADM 30 by using one optical fiber for reception (drop).

Thus, as illustrated in FIG. 8, in the aforementioned case 1, the subcarrier modulation optical signals constituting one super-channel are transmitted between the optical multiplexer and demultiplexer 130 and the MCS block 36 through one optical fiber for transmission or reception.

Accordingly, the subcarrier modulation optical signals (for example, DP-QPSK optical signals of 100 Gbps×4 wavelengths) constituting one super-channel are added to the same degree, and are dropped from the same degree.

For example, as illustrated in FIG. 9, the subcarrier modulation optical signals which are added to the ROADM node #1 and constitute one super-channel whose destination is the ROADM node #5 are transmitted to the ROADM node #5 in a route of passing the ROADM nodes #2-#3-#4. In the ROADM node #5, the dropped subcarrier modulation optical signals are input to the 1×4 optical splitter 137 through one optical fiber.

The same is true of the aforementioned cases 2 and 3. For example, as illustrated in FIG. 10, when DP-16QAM optical signals of 200 Gbps×2 wavelengths (λ1 and λ2) are transmitted as the super-channel in the case 2, the modulation optical signals having the wavelengths (subcarriers) may be transmitted to the same degree. When DP-8QAM optical signals of 150 Gbps×3 wavelengths (λ1 to λ3) are transmitted as the super-channel in the case 3, the modulation optical signals having the wavelengths (subcarriers) may be transmitted to the same degree.

Here, in order to reduce limitations on pass band characteristics of the WSS, the subcarriers (wavelengths) constituting the super-channel may be arranged within as narrow-band as possible. Since the optical signals of one super-channel are processed as one wavelength group, an effect of reducing degradation in transmission performance arising from pass band narrowing (PBN) is obtained.

Since the multiplexed optical signals of one super-channel may be transmitted (may be referred to as “accommodated”) to one optical fiber for transmission or reception, the connection between the MTPD 10 and the ROADM 30 may not be performed using an optical fiber in a unit of the subcarrier. For this reason, for example, since it is easy to avoid a partial optical fiber obstruction and since it is easy to avoid a signal interruption due to misconnection of the optical fiber, survivability of the optical signals is improved.

There is such a merit, but in the MTPD 10 illustrated in FIGS. 6 to 9, when the remaining NBO module 12 tries to transmit and receive additional subcarrier optical signals as in the aforementioned case 4 or case 5, the following inconvenience may occur.

The case 4 is, for example, a case where there are two sets of multi-carrier optical signals (DP-16QAM optical signals of 200 Gbps×2 wavelengths). Two sets of multi-carrier optical signals may be respectively super-channel optical signals. The case 5 is, for example, a case where multi-carrier optical signals (DP-8QAM optical signals of 150 Gbps×3 wavelengths) and a single-carrier optical signal (DP-QPSK optical signal of 100 Gbps×1 wavelength) are combined. The multi-carrier optical signals (DP-8QAM optical signals×3 wavelengths) may be super-channel optical signals.

In these case 4 and case 5, two multi-carrier optical signals, or a combination of a multi-carrier optical signal and a single-carrier optical signal are transmitted through one optical fiber without being separated between the MTPD 10 and the MCS block 36.

Thus, it is difficult to transmit two multi-carrier optical signals or a combination of a multi-carrier optical signal and a single-carrier optical signal to different degrees (may be referred to as “assign”). In other words, in the case 4 or case 5, it is not possible to realize the directionless function which is one of the CDC functions for additional multi-carrier optical signal or single-carrier optical signal.

Thus, for example, as illustrated in FIG. 11, in the case 4, it is difficult to transmit first multi-carrier optical signals (λ1 and λ2) and second multi-carrier optical signals (λ3 and λ4).

In the example of FIG. 11, the first multi-carrier optical signals (λ1 and λ2) which are added to the node #1 and in which a destination is the node #5 are transmitted in a route of passing the node #2-#3-#4, reach the node #5, and are dropped to a 2×1 WSS 136 of a MTPD #3 in the node #5.

However, even though the second multi-carrier optical signals (λ3 and λ4) whose destination is the node #6 are added to the node #1, it is difficult to transmit the optical signals to degrees (adjacent node #6) different from the output degrees of the first super-channel optical signals.

As stated above, when the degrees to which the optical signals are transmitted (assigned) are not freely selected independently in a unit of the subcarrier, it is inconvenient due to limitations on the configuration or controlling of the signal channel in the WDM optical transmission system 1. Thus, for example, it is also difficult to secure communication channels when a disaster or an obstruction occurs.

### First Modification Example

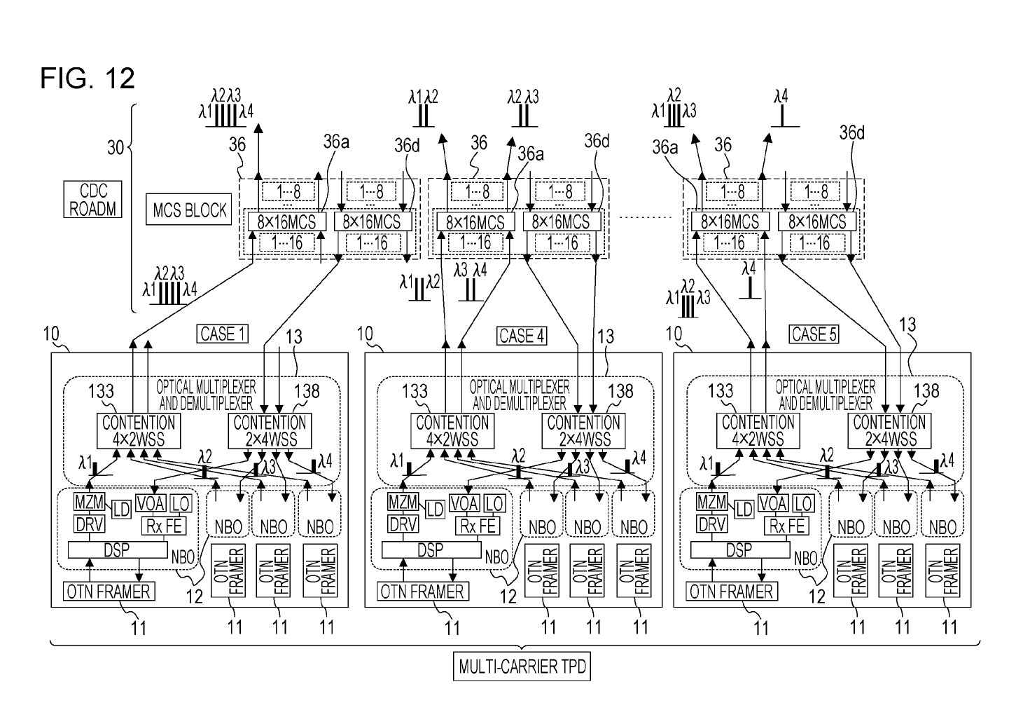

Next, a first modification example of the aforementioned embodiment will be described with reference to FIG. 12. FIG. 12 is a block diagram illustrating an example of a connection relationship between a MTPD and a ROADM according to the first modification example, and is a diagram corresponding to FIG. 3.

A MTPD 10 illustrated in FIG. 12 is different from the MTPD 10 illustrated in FIGS. 1A, 2 and 3 in that the configuration of an optical multiplexer and demultiplexer 13 is different. For example, the optical multiplexer and demultiplexer 13 illustrated in FIG. 12 includes a contention 4×2 WSS 133 instead of the 4×1 optical coupler 131 and the 1×2 WSS 132 for add illustrated in FIGS. 1A, 2 and 3. The optical multiplexer and demultiplexer 13 illustrated in FIG. 12 includes a contention 2×4 WSS 138 instead of the 2×1 WSS 136 and the 1×4 optical splitter 137 for add illustrated in FIGS. 1A, 2 and 3.

The contention 4×2 WSS 133 includes four input ports and two output ports, and is an example of an optical device capable of selectively outputting light input to the input ports to any of the output ports in a unit of the wavelength.

The contention 4×2 WSS 133 does not have the contentionless (non-blocking). In other words, when light waves having the same wavelength are input to different input ports, since wavelength contention occurs, the contention 4×2 WSS 133 does not allow light waves having the same wavelength to be input to different input ports.

For example, it will be understood that the contention 4×2 WSS 133 is an example of an optical device in which a function as an example of the wavelength selection unit implemented using the 4×1 optical coupler 131 and the 1×2 WSS 132 described in FIGS. 1A, 2 and 3 is implemented using one WSS.

The input ports of the contention 4×2 WSS 133 are optically connected to the output ports of the NBO modules 12 one by one. The output ports of the contention 4×2 WSS 133 are optically connected to any of the input ports of the 8×16 MCS 36a for add. The optical connection may be performed using an optical fiber.

The contention 2×4 WSS 138 includes two input ports and four output ports, and is an example of an optical device capable of selectively outputting light waves input to the input ports to any of the output ports in a unit of the wavelength.

The contention 2×4 WSS 138 does not have the contentionless (non-blocking). In other words, when light waves having the same wavelength are input to different input ports, since wavelength contention occurs, the contention 2×4 WSS 138 does not allow light waves having the same wavelength to be input to different input ports.

For example, it will be understood that the contention 2×4 WSS 138 is an example of an optical device in which a function as an example of the multiplexer and demultiplexer implemented using the 2×1 WSS 136 and 1×4 optical splitter 137 described in FIGS. 1A, 2 and 3 is implemented using one WSS.

The input ports of the contention 2×4 WSS 138 are optically connected to any of the output ports of the 8×16 MCS 36d for drop. The output ports of the contention 2×4 WSS 138 are optically connected to any of the input ports of the NBO modules 12 one by one. The optical connection may be performed using an optical fiber.

In such a configuration, similarly to the aforementioned embodiment, it is possible to freely assign the subcarrier modulation optical signals transmitted and received by the NBO module 12 to any degree in a unit of the subcarrier. For example, as illustrated in FIG. 12, in the case 1, it is possible to assign the subcarrier modulation optical signals having four wavelengths to the same degree. In the case 4, it is possible to assign two super-channel optical signals to different degrees. In the case 5, it is possible to assign the subcarrier modulation optical signals having three wavelengths constituting the super-channel and the modulation optical signal of a signal carrier to different degrees.

In any case, the optical signals assigned to the same degree are accommodated in one optical fiber for transmission or reception which is provided between the optical multiplexer and demultiplexer 13 and the MCS block 36. In other words, the optical signals directed to one degree equipped with one optical fiber are assigned. Thus, it is possible to improve survivability of the optical signals.

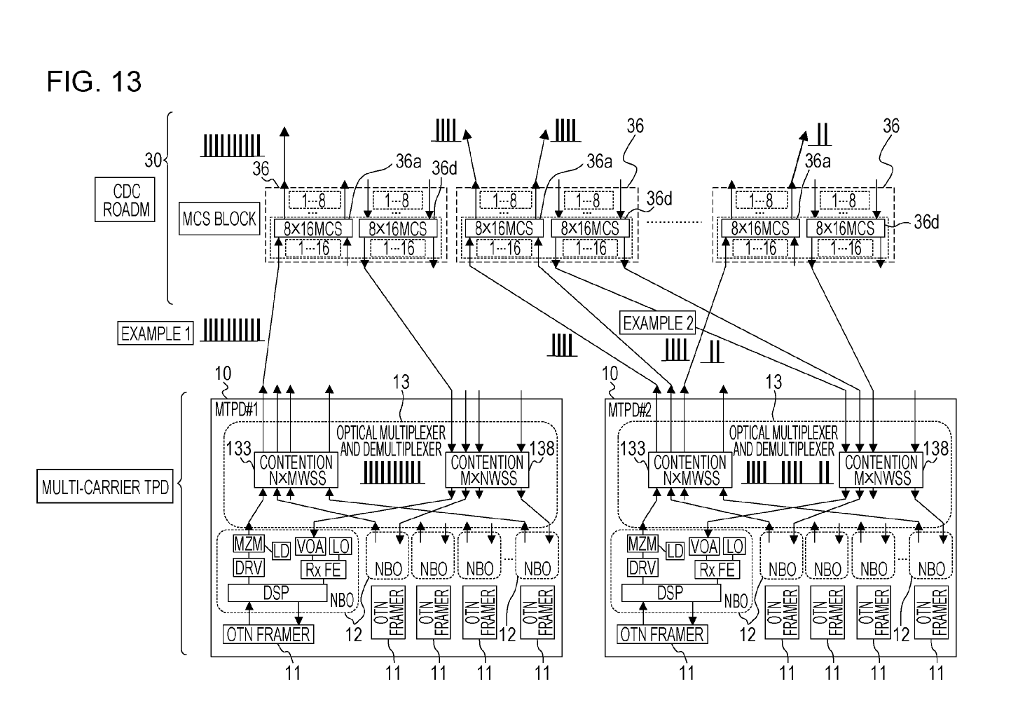

FIG. 13 is a block diagram illustrating a configuration example in which the contention 4×2 WSS 133 and the contention 2×4 WSS 138 illustrated in FIG. 12 are generalized to a contention N×M WSS 133 and a contention M×N WSS 138.

The N and M may be set so as to correspond to the number of NBO modules 12 provided in the MTPD 10. Accordingly, it is possible to change transmission capacity supported by one MTPD 10 by increasing or decreasing the number of NBO modules 12, and it is possible to easily cope with upgrading of a transmission capacity to 100 Gbps to 400 Gbps, or 1 Tbps or more.

FIG. 13 illustrates a case where a plurality of subcarrier modulation optical signals constituting one multi-carrier optical signal which is generated in a first MTPD #1 are assigned to the same degree. FIG. 13 illustrates a case where a plurality of subcarrier modulation optical signals which are generated in a second MTPD #2 and constitute three multi-carrier optical signals are assigned to different degrees.

### Second Modification Example

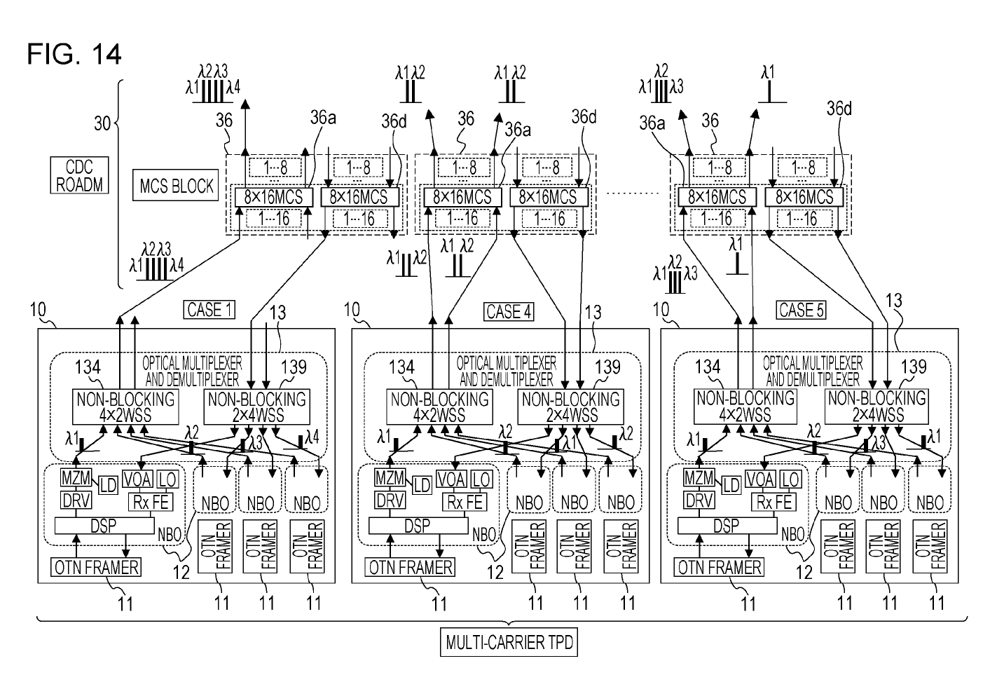

Next, a second modification example of the aforementioned embodiment will be described with reference to FIG. 14. FIG. 14 is a block diagram illustrating an example of a connection relationship between a MTPD and a ROADM according to the second modification example, and is a diagram corresponding to FIGS. 3 and 12.

A MTPD 10 illustrated in FIG. 14 is different from the MTPD 10 illustrated in FIGS. 1A, 2 and 3 in that the configuration of an optical multiplexer and demultiplexer 13 is different. For example, the optical multiplexer and demultiplexer 13 illustrated in FIG. 14 includes a non-blocking 4×2 WSS 134 instead of the 4×1 optical coupler 131 and the 1×2 WSS 132 for add illustrated in FIGS. 1A, 2 and 3. The optical multiplexer and demultiplexer 13 illustrated in FIG. 14 includes a non-blocking 2×4 WSs 139 instead of the 2×1 WSS 136 and the 1×4 optical splitter 137 for drop illustrated in FIGS. 1A, 2 and 3.

The non-blocking 4×2 WSS 134 includes four input ports and two output ports, and is an example of an optical device capable of selectively outputting light waves input to the input ports to any of the output ports in a unit of the wavelength without contention of the same wavelength (contention less).

In other words, the non-blocking 4×2 WSS 134 is an example of an optical device in which a function as an example of the wavelength selection unit implemented using the optical coupler 131 and the WSS 132 described in FIGS. 1A, 2 and 3 and the contentionless function are implemented using one WSS.

Since the non-blocking 4×2 WSS has the contentionless, light waves having the same wavelength may be input to the input ports of the non-blocking 4×2 WSS 134. Accordingly, a plurality of subcarrier modulation optical signals whose wavelength bands are overlapped (in other words, including the same wavelength) may be input to the non-blocking 4×2 WSS 134.

The input ports of the non-blocking 4×2 WSS 134 are optically connected to the output ports of the NBO modules 12 one by one. The output ports of the non-blocking 4×2 WSS 134 are optically connected to any of the input ports of the 8×16 MCS 36a for add. The optical connection may be performed using an optical fiber.

The non-blocking 2×4 WSS 139 includes two input ports and four output ports, and is an example of an optical device capable of selectively outputting light waves input to the input ports to any of the output ports in a unit of the wavelength without contention of the same wavelength (contention less).

In other words, the non-blocking 2×4 WSS 139 is an example of an optical device in which a function as an example of the optical multiplexer and demultiplexer implemented using the WSS 136 and the optical splitter 137 described in FIGS. 1A, 2 and 3 and the contentionless function are implemented using one WSS.

Since the non-blocking 2×4 WSS has the contentionless, light waves having the same wavelength may be input to the non-blocking 2×4 WSS 139. Accordingly, a plurality of subcarrier modulation optical signals whose wavelength bands are overlapped (in other words, including the same wavelength) may be input to the non-blocking 2×4 WSS 139.

The input ports of the non-blocking 2×4 WSS 139 are optically connected to any of the output ports of the 8×16 MCS 36d for drop. The output ports of the non-blocking 2×4 WSS 139 are optically connected to the input ports of the NBO modules 12 one by one. The optical connection may be performed using an optical fiber.

As mentioned above, it is possible to freely assign the subcarrier modulation optical signals transmitted and received by the NBO modules 12 to any degree in a unit of the subcarrier while having the contentionless by using the non-blocking WSS in the optical multiplexer and demultiplexer 13.

Since the non-blocking 2×4 WSS has the contentionless, for example, in the case 4 or case 5, a plurality of multi-carrier signals whose wavelength bands are overlapped is allowed to be input to the optical multiplexer and demultiplexer 13. Accordingly, for example, in the case 4, even though the same wavelength is included in two multi-carrier optical signals, it is possible to assign the multi-carrier optical signals to different degrees. For example, FIG. 14 illustrates an example in which two wavelengths (λ1 and λ2) constituting two multi-carrier signals are the same.

In the case 5, even though any of a plurality of wavelengths constituting one multi-carrier optical signal and a wavelength of a single-carrier optical signal are the same, it is possible to assign the multi-carrier optical signal and the single-carrier optical signal to different degrees.

As mentioned above, since the wavelength capable of being assigned to different degrees is not limited to different wavelengths, it is possible to improve flexibility in a utilization form of the NBO module 12. In the second modification example, since the optical signals directed to one degree equipped with one optical fiber are assigned, it is possible to improve survivability of the optical signals.

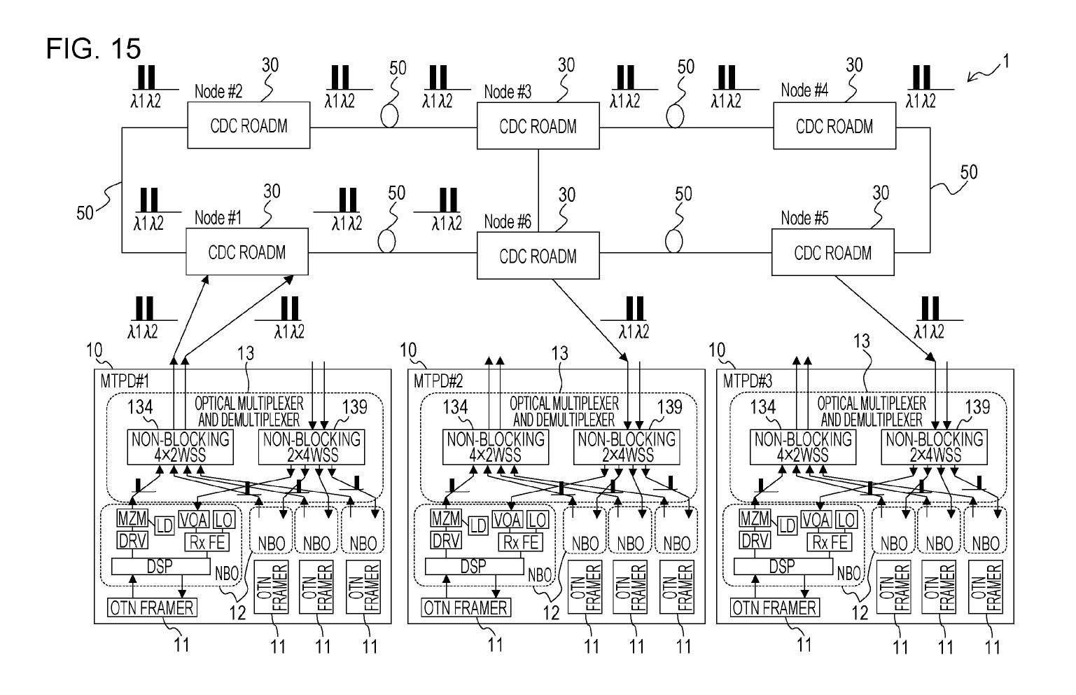

FIG. 15 is a block diagram illustrating a configuration example in which the MTPD 10 illustrated in FIG. 13 is applied to the WDM optical transmission system 1 including a plurality of ROADMs (CDC ROADMs) 30 having the CDC functions, and is a diagram corresponding to FIG. 5. FIG. 15 illustrates a case where two super-channel optical signals having the same wavelengths λ1 and λ2 are transmitted to different degrees in the case 4.

For example, first super-channel optical signals (λ1 and λ2) are transmitted in a route of passing the nodes #1-#2-#3-#4, reach the node #5, and are dropped to the non-blocking 2×4 WSS 139 of the MTPD #3 in the node #5. Meanwhile, second super-channel optical signals (λ1 and λ2) are transmitted from the node #1 to the adjacent node #6, and are dropped to the non-blocking 2×4 WSS 139 of the MTPD #2 in the node #6.

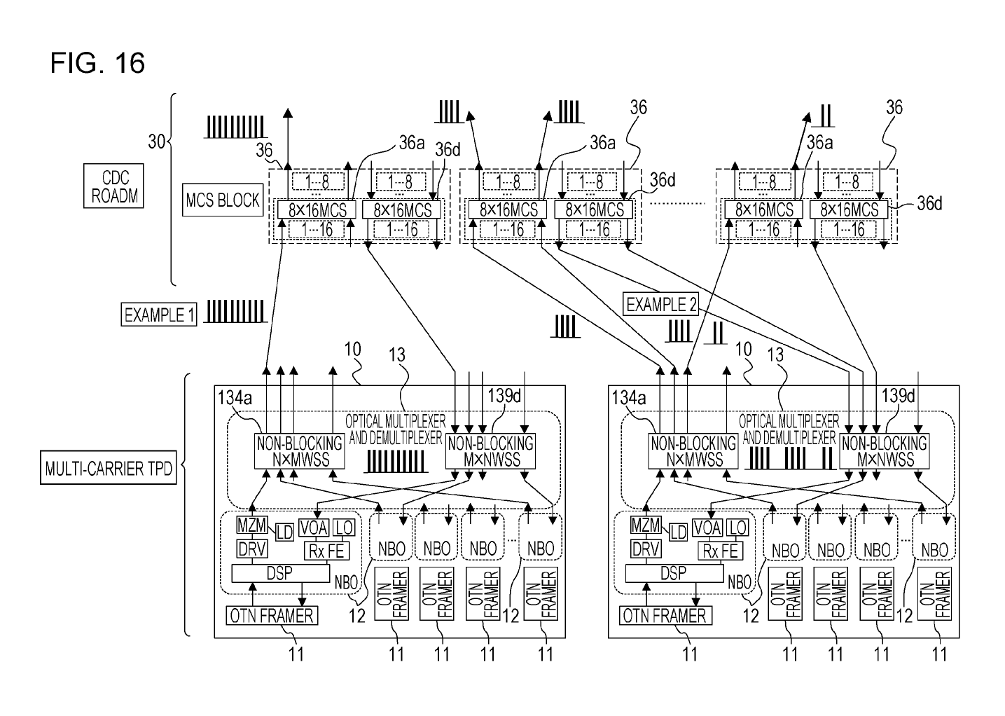

FIG. 16 is a block diagram illustrating a configuration example in which the non-blocking 4×2 WSS 134 and the non-blocking 2×4 WSS 139 illustrated in FIG. 14 are respectively generalized to a non-blocking N×M WSS 134a and a non-blocking M×N WSS 139d.

Similarly to FIG. 13, the N and M may be set so as to correspond to the number of NBO modules 12 provided in the MTPD 10. Accordingly, it is possible to change transmission capacity supported by one MTPD 10 by increasing or decreasing the number of NBO modules 12, and it is possible to easily cope with upgrading of a transmission capacity to 100 Gbps to 400 Gbps, or 1 Tbps or more.

### Third Modification Example

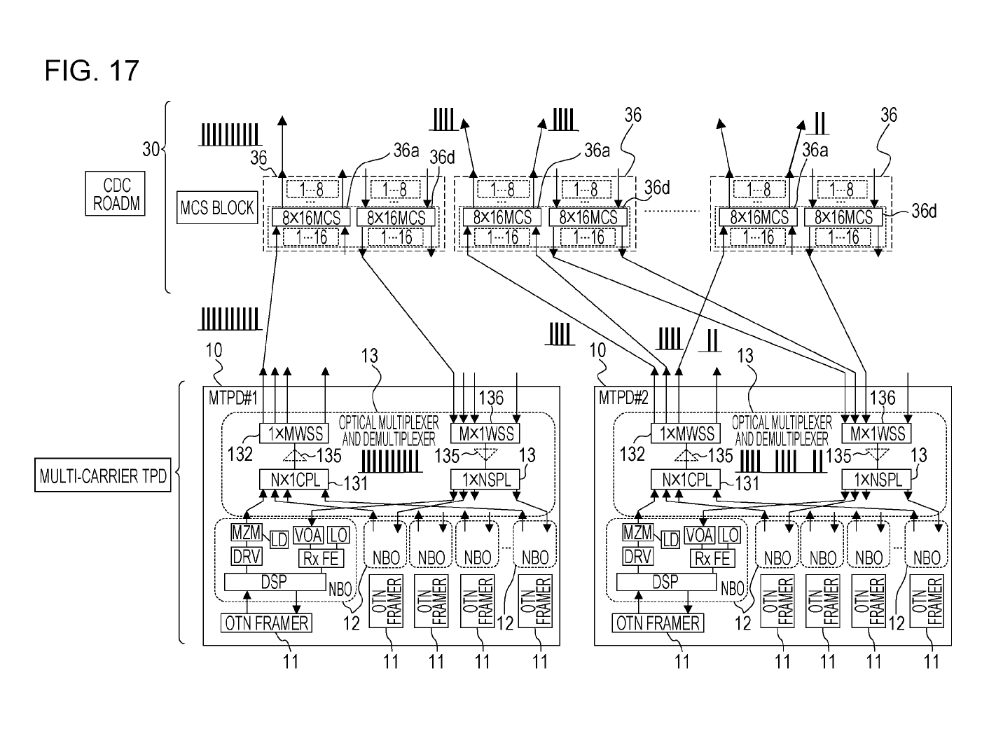

FIG. 17 is a block diagram illustrating a configuration example in which the number of input ports in the optical coupler 131, the WSS 132, the WSS 136, and the optical splitter 137 illustrated in FIGS. 1A, 2 and 3 is generalized.

As the value of the N is increased in proportion to the number of NBO modules 12 provided in the MTPD 10, the insertion loss of the N×1 optical coupler 131 and the 1×N optical splitter 137 is increased, the loss of the subcarrier optical signals is increased. In order to compensate for the loss, the optical amplifier 135 may be provided between the N×1 optical coupler 131 and the 1×M WSS 132 and between the M×1 WSS 136 and the 1×N optical splitter 137.

Similarly to FIG. 13, FIG. 17 illustrates a case where a plurality of subcarrier modulation optical signals which is generated in the first MTPD #1 and constitutes one multi-carrier optical signal is assigned to the same degree. FIG. 17 illustrates a case where a plurality of subcarrier modulation optical signals which is generated in the second MTPD #2 and constitutes three multi-carrier optical signals is assigned to different degrees.

Others

In the aforementioned embodiment and modification examples, it has been described that the MTPDs 10 connected to the ROADM 30 support a plurality of modulation formats. However, transponders that support a single modulation format may be connected to the ROADM 30. In other words, the MTPDs 10 that support a plurality of modulation formats and the existing transponders that support a single modulation format may be connected to one ROADM 30.

The function as the wavelength selective switch (WSS) described in the aforementioned embodiment and modification examples may be implemented using the optical filter. The optical multiplexer and demultiplexer included in FIGS. 2, 3, and 5 to 17 may be applied to the configuration of the optical multiplexer and demultiplexer 13 described in FIGS. 1B and 1C.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical transmitter, comprising:
a plurality of optical modulators, each and a driver by which a modulation format is variable; and
a wavelength selection unit configured to selectively outputs modulation optical signals generated by the optical modulators to a first output port corresponding to a first optical transmission degree and a second output port corresponding to a second optical transmission degree in a unit of wavelength.

2. The optical transmitter according to claim 1, wherein a first modulation optical signal group that is selectively output to the first output port constitutes a first multi-carrier optical signal, and a second modulation optical signal group that is selectively output to the second output port constitutes a second multi-carrier optical signal.

3. The optical transmitter according to claim 1, wherein the wavelength selection unit includes:
a coupler that multiplexes the modulation optical signals generated by the optical modulators, and
a wavelength selective switch that selectively outputs output light of the coupler to any one of the first and second output ports in the unit of wavelength.

4. The optical transmitter according to claim 1, wherein the wavelength selection unit includes:
a coupler that multiplexes the modulation optical signals generated by the optical modulators, and
at least one tunable filter that selects a wavelength from output light of the coupler, and outputs light having the selected wavelength to any one of the first and second output ports.

5. The optical transmitter according to claim 1, wherein the wavelength selection unit includes a blocking wavelength selective switch that receives modulation optical signals having different wavelengths, and selectively outputs the received modulation optical signals to any one of the first and second output ports in the unit of wavelength.

6. The optical transmitter according to claim 1, wherein the wavelength selection unit includes a non-blocking wavelength selective switch that receives a plurality of modulation optical signals including signals having the same wavelength, and selectively outputs the received modulation optical signals to any one of the first and second output ports in the unit of wavelength.

7. The optical transmitter according to claim 3, wherein an optical amplifier is provided between the coupler and the wavelength selective switch.

8. The optical transmitter according to claim 1, wherein the first and second output ports are connected to a degree selection unit of the optical transmitter, which selects the optical signals transmitted to the first and second optical transmission degrees in the unit of wavelength.

9. An optical receiver comprising:
an optical multiplexer and demultiplexer that multiplexes and demultiplexes one or a plurality of first modulation optical signals which are input to a first input port corresponding to a first optical transmission degree and are modulated using a variable modulation format, and one or a plurality of second modulation optical signals which are input to a second input port corresponding to a second optical transmission degree and are modulated using a variable modulation format, in a unit of wavelength; and
a plurality of reception units that receive the modulation optical signals demultiplexed in the optical multiplexer and demultiplexer.

10. The optical receiver according to claim 9, wherein the plurality of first modulation optical signals constitute a first multi-carrier optical signal, and the plurality of second modulation optical signals constitute a second multi-carrier optical signal.

11. The optical receiver according to claim 9, wherein the optical multiplexer and demultiplexer includes:
a wavelength selective switch that selectively outputs the modulation optical signals input to the first and second input ports in the unit of wavelength, and
an optical splitter that demultiplexes output light waves of the wavelength selective switch, and outputs the demultiplexed output light waves to the reception units.

12. The optical receiver according to claim 9, wherein the optical multiplexer and demultiplexer includes a blocking wavelength selective switch that receives modulation optical signals having different wavelengths, and selectively outputs the received modulation optical signals to any of the reception units in the unit of wavelength.

13. The optical receiver according to claim 9, wherein the optical multiplexer and demultiplexer includes a non-blocking wavelength selective switch that receives a plurality of modulation optical signals including signals having the same wavelength, and selectively outputs the received modulation optical signals to any of the reception units in the unit of wavelength.

14. The optical receiver according to claim 11, wherein an optical amplifier is provided between the wavelength selective switch and the optical splitter.

15. The optical receiver according to claim 9, wherein the first and second output ports are connected to a degree selection unit of an optical transmitter, which selects the optical signals transmitted to the first and second optical transmission degrees in the unit of wavelength.

16. An optical transmission method. comprising:
generating a plurality of modulation optical signals by a plurality of optical modulators in which a modulation format is variable; and
selectively outputting the modulation optical signals to at least any one of a first output port corresponding to a first optical transmission degree and a second output port corresponding to a second optical transmission degree in a unit of wavelength.

17. The optical transmitter according to claim 1, wherein the optical modulators have a different transmission speed and a different modulation format of the modulation optical signals.

18. The optical transmission method according to claim 16, wherein the modulation optical signals include a different transmission speed and a different modulation format of the modulation optical signals.
